(19) United States
(12) Patent Application Publication
(10) Pub. No.: US 2013/0144549 A1
(43) Pub. Date: Jun. 6, 2013

(54) METHOD FOR CALIBRATING TEMPERATURE SENSORS USING REFERENCE VOLTAGES

(71) Applicants: Grigori Temkine, Markham (CA); Filipp Chekmazov, Toronto (CA); Paul Edelshteyn, Toronto (CA); Oleg Drapkin, Richmond Hill (CA); Kristina Au, Richmond Hill (CA)

(72) Inventors: Grigori Temkine, Markham (CA); Filipp Chekmazov, Toronto (CA); Paul Edelshteyn, Toronto (CA); Oleg Drapkin, Richmond Hill (CA); Kristina Au, Richmond Hill (CA)

(21) Appl. No.: 13/309,223

(22) Filed: Dec. 1, 2011

(51) Int. Cl. G01K 15/00; G06F 19/00

(52) U.S. Cl. 702/99

(57) ABSTRACT

A system and method for calibrating integrated circuit (IC) temperature measurement circuits. An integrated circuit (IC) includes a thermal sensor and data processing circuitry. The IC may have a temperature measurement mode of operation and a calibration mode of operation. During the calibration mode, one or more stable reference voltages, rather than sensed voltages from a thermal sensor, are selected as input voltages to the data processing circuitry. Electronic components within the data processing circuitry receive the stable reference voltages and generate a temperature digital code. The generated temperature digital code may be compared to an expected temperature digital code based on theoretical ideal gains for each of the components within the data processing circuitry. The comparison leads to an updated value for a scaling factor to be stored and used in subsequent temperature measurements.

### BACKGROUND OF THE INVENTION

1. Field of the Invention

This invention relates to electronic circuits, and more particularly, to calibrating integrated circuit (IC) temperature measurement circuits.

2. Description of the Relevant Art

In electronic systems, various processes may be used to monitor the temperature(s) of one or more devices in order to effectively control the system. Such processes may be used in systems relating to manufacturing, automotive, laptop computers, smart phones, mobile devices, and otherwise. Temperature sensors may be used to aid in allowing integrated circuits (IC) to operate under safe thermal conditions, and to both conserve battery power and prevent damage to on-die transistors. In some cases, these processes may use the temperature of an integrated circuit (IC) (e.g., the temperature of the substrate) for measurement.

Integrated circuit (IC) temperature sensors typically use the property that the difference in forward voltage of a silicon junction (e.g., a pn junction) is proportional to temperature. The Base-Emitter voltage, V_{BE}, of a bipolar junction transistor (BJT) is an example of a forward voltage of a silicon pn junction. Temperature measurements of an IC may be performed by measuring the V_{BE} of a diode-connected BJT at different current densities at a given location of interest. When a ratio of current densities is set to a given constant value, the measured difference between the two voltage values is proportional to the temperature of the diode-connected BJT. Differences between the two measured voltage values may be referred to as the delta V_{BE}, or ΔV_{BE}.

The analog voltage measured across one or more diodes in a ΔV_{BE} IC temperature sensor may be sent to a series of multiple circuit components. Measured voltages may have differences on the order of tens of millivolts, where an acceptable measurement accuracy may be within tens to hundreds of microvolts. The output of the series may then provide a digital code representing a temperature value. The series of multiple components may include at least a sampling circuit, a filter, an amplifier, an analog-to-digital converter (ADC), and so forth. Generally speaking, each of the multiple components has an associated individual (expected) gain, and a total gain of the series is proportional to a product of these individual gains. However, due to manufacturing imperfections, the actual gain of a given component in the series may differ from the expected gain. This difference between the expected and actual gain may be referred to as a gain error. While a single gain error may or may not result in significant inaccuracies in temperature measurements, an accumulation of such gain errors may increase the likelihood of a significant inaccuracy in temperature measurement. To address such errors and achieve an acceptable tolerance for the temperature measurement accuracy, the gain of the temperature measurement circuitry may be calibrated.

Various methods exist for calibrating individual circuit components, such as ADCs and amplifiers, in either production testing environments or in real time. For example, methods exist for calibrating an ADC that use voltage references, potentially derived from a bandgap. However, real-time calibration of individual components adds circuit complexity and area. In addition, calibration of the gain of some but not all individual circuit components may not achieve an acceptable tolerance for the temperature measurement accuracy. The reason is the gain of the entire signal path from the diode to the digitized temperature data is important for measurement accuracy, and the ADC is only one of the components in the signal path that may contribute to the entire gain error. In addition to the above, temperature sensors can be calibrated in their entirety by performing temperature readouts at one or more temperature points using a temperature-controlled test environment. Later, these readouts are adjusted to match the controlled temperature. However, production-level testing of multiple components at one or more precisely controlled temperature points is expensive in terms of tester time.

In view of the above, efficient methods and systems for calibrating integrated circuit (IC) temperature measurement circuits are desired.

### SUMMARY OF EMBODIMENTS OF THE INVENTION

Systems and methods for calibrating integrated circuit (IC) temperature measurement circuits are contemplated.

In one embodiment, an integrated circuit (IC) includes a thermal sensor and data processing circuitry. The thermal sensor utilizes switched currents provided to one or more diodes. The ratios of the currents provided to the one or more diodes either concurrently and/or sequentially may be chosen to provide a given delta value between the resulting sampled diode voltages. During a temperature measurement mode of operation, the sensed diode voltages are selected as inputs to the data processing circuitry. A differential amplifier within the data processing circuitry may receive the analog sampled voltages and determine the delta values. Other components within the data processing circuitry may at least digitize the delta values and generate a temperature digital code. Each of the components may have an associated gain. Due to manufacturing imperfections, each gain of each component may have an appreciable error. The data path between the selected input voltages received by the data processing circuitry and a generated output digital code that represents temperature of the diode's pn junction accumulates the individual gain errors. The generated temperature digital code is adjusted with a stored scaling factor.

During a calibration mode of operation, one or more stable calibration reference voltages from a bandgap circuit or other reference source are selected as input voltages to the data processing circuitry. The differential amplifier within the data processing circuitry may receive the stable reference voltages and determine delta values. Other components within the data processing circuitry may at least digitize the delta values and generate a temperature digital code. The generated temperature digital code may be compared to an expected temperature digital code based on theoretical ideal gains for each of the components within the data processing circuitry. The comparison leads to an updated value for the scaling factor to be stored and used in subsequent temperature measurements.

These and other embodiments will be further appreciated upon reference to the following description and drawings.

### BRIEF DESCRIPTION OF THE DRAWINGS

FIG. 1 is a generalized block diagram of one embodiment of a temperature monitor.

FIG. 2 is a generalized block diagram of one embodiment of a data acquisition and processing system.

FIG. 3 is a generalized block diagram of one embodiment of voltage sensing and calibration waveforms.

FIG. 4 is a generalized block diagram of another embodiment of voltage sensing and calibration waveforms.

FIG. 5 is a generalized block diagram of another embodiment of voltage sensing and calibration waveforms.

FIG. 6 is a generalized flow diagram of one embodiment of a method for on-chip calibration of temperature measurement circuitry.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention.

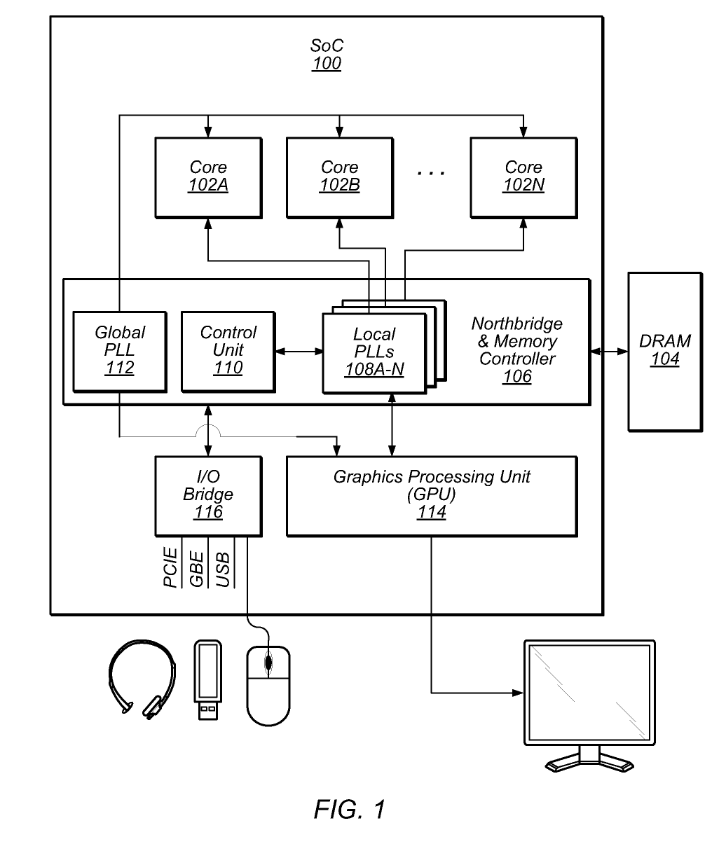

Referring to FIG. 1, one embodiment of a temperature monitor 100 is shown. As shown, the temperature monitor 100 may include a thermal detector 110 that provides one or more sampled voltages that may be proportional to absolute temperature. In one embodiment, the temperature detector 110 may measure the substrate temperature of a given location within an integrated circuit (IC). The integrated circuit may be a processor core, an application specific integrated circuit (ASIC), a memory, and so forth. The thermal detector 110 may be used in a cooling system for the integrated circuit, such as a performance-power operational mode/state selector, a fan controller, and so forth.

The thermal detector 110 may sense a substrate temperature of an IC with circuitry within the current sources 120, the switches 130 and the thermal sensor 150. The current sources 120 may include one or more current sources. As shown, the current sources 120 include at least two current sources 122 and 124 for supplying the currents I1 and I2. However, in various embodiments, multiple currents may be generated from a single master current source, wherein one or more currents are an integer multiple of a given current.

The switches 130 may include one or more switches. As shown, the switches 130 include at least two switches S1 and S2 for supplying currents I1 and I2 to the thermal sensor 150. However, in various embodiments, a single current may be supplied by the current sources 120 and a single switch is used to provide it to the thermal sensor 150.

In one embodiment, the switches 130, such as S1 and S2, are complementary metal oxide semiconductor (CMOS) transmission gates formed by an NFET and a PFET connected in parallel. Other implementations for the switches are possible and contemplated. The switches S1 and S2 may be controlled by clock signals provided by the control logic 140. Although a single line 142 is shown for the clock signals for ease of illustration, it is understood multiple lines may be used for providing multiple clock signals. In one embodiment, the clock signals may be asserted in a manner to cause the switches S1 and S2 to close at a same time and reopen at a later different time. The frequency and duty cycle of each of the clock signals may follow a given temperature sampling period. The control logic 140 may determine when to transition the clock signals.

The thermal sensor may include one or more diodes for measuring substrate temperature of an IC. As shown, the thermal sensor 150 includes at least two diodes 152 and 154 for providing diode voltages in response to supplied switch currents flowing through the diodes. However, in various embodiments, a single diode may be used and its diode voltage may be sampled at two different points in time and compared.

The currents I1 and 12, which are sourced by current sources 122 and 124, may flow to the thermal sensor 150 when the switches S1 and S2 are closed. In one embodiment, the current 12 is an integer multiple of the current I1 . When the currents I1 and I2 flow to the thermal sensor 150, the voltages V1 and V2 on lines 156 and 158 may change value based on at least the substrate temperature and the ratio of the currents I1 and I2.

The thermal sensor 150 may be placed in a location of interest on an integrated circuit (IC). The substrate temperature of a given location on the IC may be measured by sampling the forward voltage of a silicon pn junction of a given diode at two different current densities. The voltages V1 and V2 may indicate the diode voltages.

In some embodiments, each of the diodes 152 and 154 may be a circuit utilizing a transistor, such as a parasitic vertical PNP bipolar junction transistor (BJT). In other embodiments, each of the diodes 152 and 154 may be a PN junction diode, a diode-connected BJT, a diode-connected FET, or any other suitable circuit for providing an indication of substrate temperature. When the forward voltage of a silicon pn junction of a given diode is sampled at two different current densities, the difference between the sampled voltages depends on the ratio of the two different current densities.

When a BJT is used to implement a diode, the difference between the two sampled Base-Emitter voltages, may be expressed as ΔV_{BE}=Vₜ×μ×ln(J₂/J₁). Here, “Vₜ” is the thermal voltage. The thermal voltage equals k×T/q, where “k” is Boltzmann's constant 1.381×10⁻²³ Joules/Kelvin, “T” is the absolute temperature of the diode in degrees Kelvin, and “q” is the electron charge value 1.602×10⁻¹⁹ coulombs. The BJT ideality factor, “μ”, is a constant for a given process and a range of BJT current densities. Values for the ideality factor, “μ”, may vary between 1 and 2. The term “J₂/J₁” is the ratio of the current densities.

When the ratio of current densities, “J₂/J₁”, is set to a constant value, the ΔV_{BE} value may be proportional to the absolute temperature “T”. The ΔV_{BE} value may be referred to as the PTAT Voltage (Proportional To Absolute Temperature). For typical “J₂/J₁” ratios, the dependence of the ΔV_{BE} value on temperature may be in the range of 100 microvolts (uV) to 200 uV per one degree Kelvin. Therefore, measuring the ΔV_{BE} value may provide an indication of the BJT junction temperature “T”.

The voltages V1 and V2 on lines 156 and 158 are sent to selectors 170. In addition, a reference voltage supply 160 sends one or more reference voltages, such as V3 and V4 on lines 162 and 164, to the selectors 170. A bandgap circuit may generate the reference voltages. A bandgap voltage reference is a temperature independent voltage reference circuit widely used in integrated circuits. In one example, the output voltage may be close to the theoretical 1.22 eV bandgap of silicon at 0 degrees Kelvin. In other examples, the bandgap circuit may provide a different output voltage value. The bandgap circuit may be stable across temperature and power supply voltage. This circuit may be calibrated during production testing for process variation. A second reference voltage may be obtained from the first reference voltage by voltage division, wherein components such as well-matched resistors are used. While absolute values of impedance for resistors can vary significantly, they can be matched sufficiently well to obtain accurate differential reference voltages V3 and V4 on lines 162 and 164.

In various embodiments, operating mode logic 176 associated with thermal detector 110 may determine whether the integrated circuit is operating in a temperature measuring mode, a calibration mode, or other. In one embodiment, the selectors 170 include one or more multiplexers, such as mux gates 172 and 174. The operating mode logic 176 may provide one or more values on select lines for the mux gates 172 and 174. Although a single line 178 is shown for the select signals for ease of illustration, it is understood multiple lines may be used for providing multiple select signals to the mux gates.

The selected voltages from the voltages V1-V4 may be used as input voltages to the data processing circuitry 180. The data processing circuitry 180 may include one or more components, each with an associated gain. For example, the data processing circuitry 180 may include a differential amplifier, one or more filtering circuits, an analog-to-digital converter (ADC), and so forth. Each of these circuits may have an associated gain. The total gain of the data processing circuitry 180 corresponds to a sum of the individual gains. However, due to manufacturing imperfections, each gain of each circuit may have an appreciable error. The data path between the selected input voltages received by the data processing circuitry 180 and a digital code representing temperature generated at the output of the data processing circuitry 180 accumulate the individual gain errors.

The temperature digital code output by the data processing circuitry 180 may be sent to each of calibration logic 182 and data adjustment logic 184. During a temperature measurement operating mode, the selectors 170 choose the sampled voltages V1 and V2 as inputs to the data processing circuitry 180. In addition, the data adjustment logic 184 may adjust the received temperature digital code, denoted as Z_{TEMP}, with a scaling factor, denoted as A_{correction}. For example, the data adjustment logic 184 may calculate a product with these two values to determine the corrected temperature digital code, such as Z_{TEMP-corrected}=A_{correction}×Z_{TEMP}. The corrected temperature digital code, Z_{TEMP-corrected}, may be sent to a performance-power operational mode/state selector, a fan controller, or other. It is noted that the scaling factor (or adjustment value) may represent a multiplication, division, an offset, a value to be added or subtracted, or otherwise.

During a calibration operating mode, the selectors 170 may choose the reference voltages V3 and V4 as inputs to the data processing circuitry 180. In addition, the calibration logic 182 may update the scaling factor value, A_{correction}, by comparing the received temperature digital code, Z_{CAL}, with an expected temperature digital code, Z_{IDEAL}. The expected temperature digital code, Z_{IDEAL} may corresponds to a result of a simulated measurement wherein there is zero gain error in each of the components within the data processing circuitry 180. The expected temperature digital code, Z_{IDEAL} may be a theoretical value. The calibration logic 182 may compute A_{correction}=Z_{IDEAL}/Z_{CAL}.

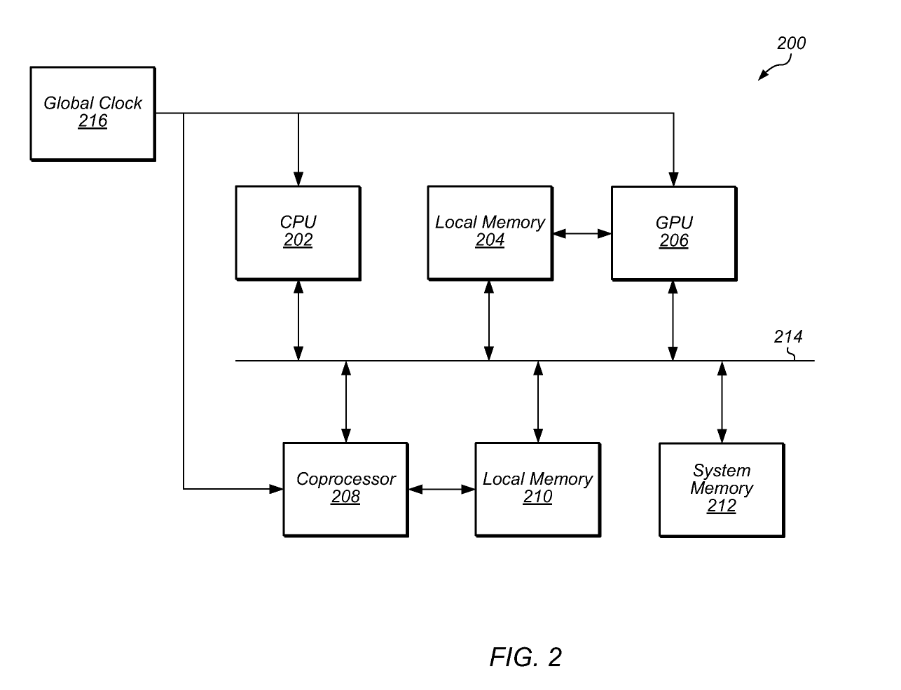

Turning now to FIG. 2, a generalized block diagram illustrating one embodiment of a data acquisition and processing system 200 is shown. Combinatorial logic and circuitry described above and used here are numbered identically. The data processing circuitry 180 receives input voltages from the mux gates 210 and 212. In one embodiment, the mux gate 210 receives a sense voltage Vsense used for temperature measurement on line 220, a first reference voltage Vcal1 used for calibration on line 230 and a second reference voltage Vcal2 used for calibration on line 232.

The mux gate 212 receives a reference voltage Vref used for temperature measurement on line 222, the first reference voltage Vcal1 used for calibration on line 230 and the second reference voltage Vcal2 used for calibration on line 232. The reference voltages Vcal1 and Vcal2 are supplied to each of the mux gates 210 and 212 in order to change values on the outputs of the mux gates 210 and 212 without generating more than two reference voltages from a bandgap circuit or another manner. Although a single line 224 is shown for the select signals for ease of illustration, it is understood multiple lines may be used for providing select signals to the mux gates 210 and 212.

The data processing circuitry may include at least a differential amplifier 240 with a gain of K1, a filter circuit 250 with a gain of K2, a generalized signal acquisition block 252 with a gain of K3, an analog-to-digital converter (ADC) 254 with a gain of Kn, another data signal processing component 260 that may represent a filter circuit or any other processing component, and temperature data converter 270. The gains K1 to Kn of components located prior to and including the ADC 254 represent analog gains that may vary and may benefit from calibration techniques. The components located after the ADC 254 have digital gains. One or more additional filtering circuits and other signal acquisition and processing blocks may be used within the data processing circuitry 180. The converter 270 may translate a digitized input value to a digital code representing temperature. The output of the converter 270 may be sent to each of the calibration logic 182 and the data adjustment logic 184. The calibration logic 182 may receive and/or store an expected temperature digital code, Z_{IDEAL} as described earlier. An updated scaling factor on line 282 may be sent from the calibration logic 182 to the data adjustment logic 184. The output of the data adjustment logic may be sent on line 292 to logic used for selecting a performance-power operating state, a fan controller, or other temperature cooling mechanism.

During a calibration operating mode, the reference voltages Vcal1 and Vcal2 generated from a bandgap circuit or other source, may be used to mimic sensing voltages during a “simulated” temperature measurement. The reference voltages Vcal1 and Vcal2 may be selected as inputs to the acquisition data path in place of the sensing voltages from a thermal sensor. The digital result at the output of the data processing circuitry 180 may be the number Z_{CAL}=(Π^{N}ₒ Kᵢ)×ΔV_{CAL}. This value is compared to the expected temperature digital code, Z_{IDEAL} as described earlier, wherein Z_{IDEAL}=(Π^{N}₀ K_{i-ideal}) ×ΔV_{CAL}. The expected temperature digital code utilizes theoretical zero gain error in each component in the acquisition and digitization circuitry within the data processing circuitry 180. A scaling factor value, A_{correction}, is then computed to null-out the measurement error of future “real”, rather than “simulated”, temperature measurements, wherein the scaling factor is A_{correction}=Z_{IDEAL}/Z_{CAL}. The updated scaling factor may be sent to the data adjustment 184 and stored.

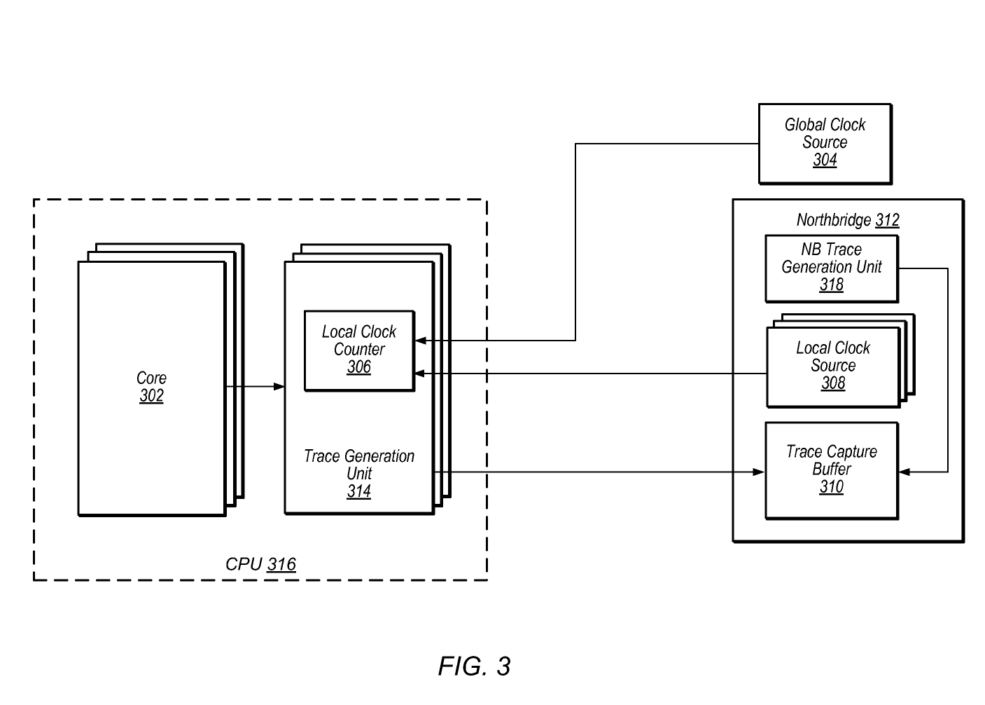

Referring now to FIG. 3, one embodiment of sensing and reference voltage waveforms for a concurrent method for measurement is shown. Two available methods for measuring a ΔV_{BE} value for diode-connected BJTs in a thermal sensor include a Concurrent Method and a Sequential Method. The Concurrent Method samples the voltages V_{BE1} and V_{BE2} at the same time to establish the ΔV_{BE} value in real time. Two separate diode-connected BJTs may be used for this measurement. The two separate BJTs may be referred to as thermal BJTs. During a temperature measurement operating mode, the voltage sensing waveforms 300 may be selected as input voltages for the data processing circuitry 180. Here, the diode voltages Vsense1 302 and Vsense2 304 are sampled from two separate diode-connected BJTs at a same time. The difference, AVₛₑₙₛₑ value may be determined by a differential amplifier at the front of the data processing circuitry 180.

During a calibration operating mode, the voltage calibration reference waveforms 320 may be selected as input voltages for the data processing circuitry 180. Here, the reference voltages Vcal1 322 and Vcal2 324 from a bandgap circuit or other reference source are sampled at a same time. A differential amplifier at the front of the data processing circuitry 180 may determine the difference ΔV_{CAL} value.

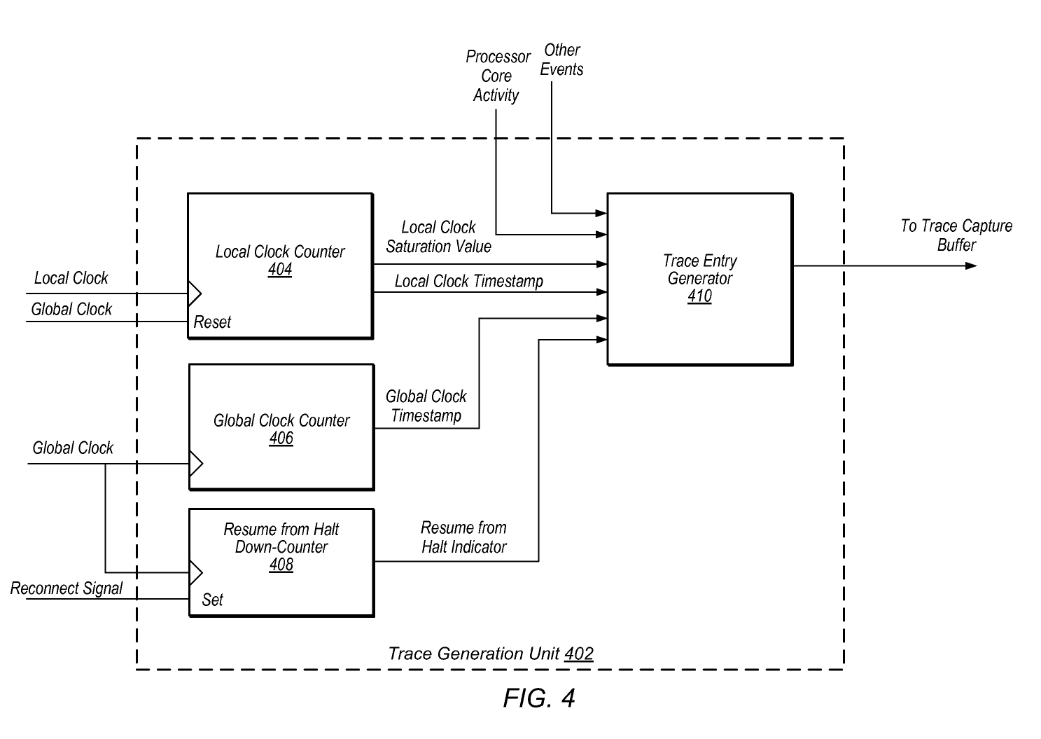

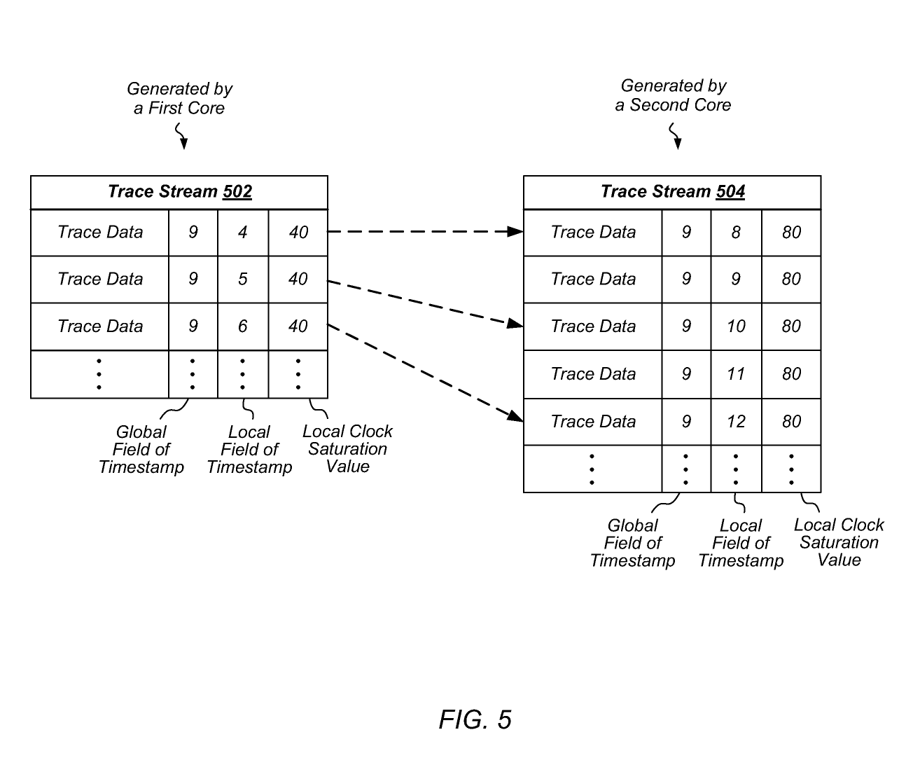

Turning now to FIG. 4, one embodiment of sensing and reference voltage waveforms for a sequential method for measurement is shown. The second available method for measuring a ΔV_{BE} value for diode-connected BJTs in a thermal sensor is a Sequential Method. The Sequential Method utilizes one thermal diode-connected BJT. The voltage value V_{BE1} may be sensed, or sampled, at a first point-in-time when a first current density, J₁, is supplied to the BJT. At a second point-in-time after the first point-in-time, the voltage value V_{BE2} may be sensed, or sampled, when a second current density, J₂, is supplied to the BJT.

During a temperature measurement operating mode, the voltage sensing waveforms 400 may be selected as input voltages for the data processing circuitry 180. Here, at a first point-in-time, the diode voltage Vsense1 402 sampled from a single diode-connected BJT and a reference voltage, which may be a ground reference, Vss 404 are sampled. In addition, at a second point-in-time after the first point-in-time, the diode voltage Vsense2 406 is sampled from the same single diode-connected BJT and the same reference voltage, which may be a ground reference, Vss 404 are sampled. A differential amplifier at the front of the data processing circuitry 180 may determine the difference ΔVₛₑₙₛₑ value.

During a calibration operating mode, the voltage calibration reference waveforms 420 may be selected as input voltages for the data processing circuitry 180. Here, at a first point-in-time, the calibration reference voltage Vcal1 422 from a bandgap circuit or other reference source, and a reference voltage, which may be a ground reference, Vss 404 are sampled. In addition, at a second point-in-time after the first point-in-time, the calibration reference voltage Vcal2 426 from a bandgap circuit or other reference source, and the reference voltage Vss 404 are sampled. A differential amplifier at the front of the data processing circuitry 180 may determine the difference ΔV_{CAL} value.

Turning now to FIG. 5, one embodiment of sensing and reference voltage waveforms for a double differential method for measurement is shown. Two separate diode-connected BJTs may be used for this measurement. The two separate BJTs may be referred to as thermal BJTs. During a temperature measurement operating mode, the voltage sensing waveforms 500 may be selected as input voltages for the data processing circuitry 180. Here, at a first point-in-time, the diode voltage Vsense1 502 sampled from a first diode-connected BJT and a reference voltage Vref 504 sampled from a second diode-connected BJT are sampled. The two voltages are sampled differentially, resulting in a voltage difference value ΔV_{sense1/2}.

In addition, at a second point-in-time after the first point-in-time, the diode voltage Vsense2 506 is sampled from the first single diode-connected BJT with a different current flowing through it and the same reference voltage Vref 504 provided by the second diode-connected BJT are sampled. The two voltages are sampled differentially, resulting in a voltage difference value ΔV_{sense2/2}. The measured delta values ΔV_{sense1/2} and ΔV_{sense2/2} may be the same.

During a calibration operating mode, the voltage calibration reference waveforms 520 may be selected as input voltages for the data processing circuitry 180. Here, at a first point-in-time, the calibration reference voltage Vcal1 522 from a bandgap circuit or other reference source, and a reference voltage Vcal2 524 from the same bandgap circuit or other reference source are sampled. The two voltages are sampled differentially, resulting in a voltage difference value ΔV_{CAL1}.

In addition, at a second point-in-time after the first point-in-time, the calibration reference voltages Vcal1 522 and Vcal2 524 may be switched and sampled. The two voltages are sampled differentially, resulting in a voltage difference value ΔV_{CAL2}. The measured delta values ΔV_{CAL1} and ΔV_{CAL2} may be the same. The switching of the calibration reference voltages Vcal1 522 and Vcal2 524 may eliminate offset errors in the signal path. If the offset errors had remained, then they may have been amplified and adversely affected the calibration result. Therefore, the switching of the calibration reference voltages Vcal1 522 and Vcal2 524 may provide a more accurate calibration result.

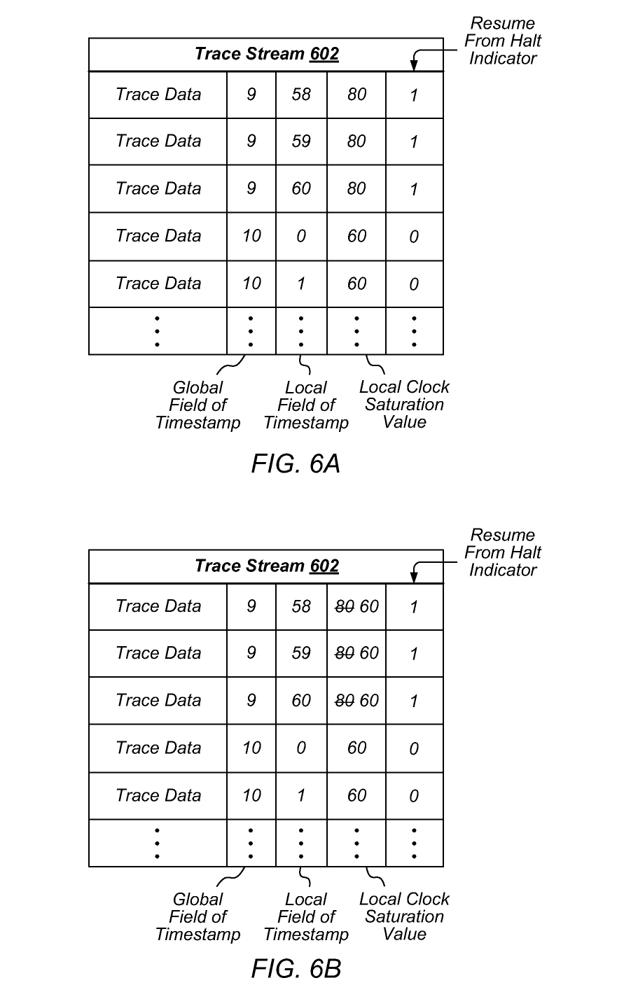

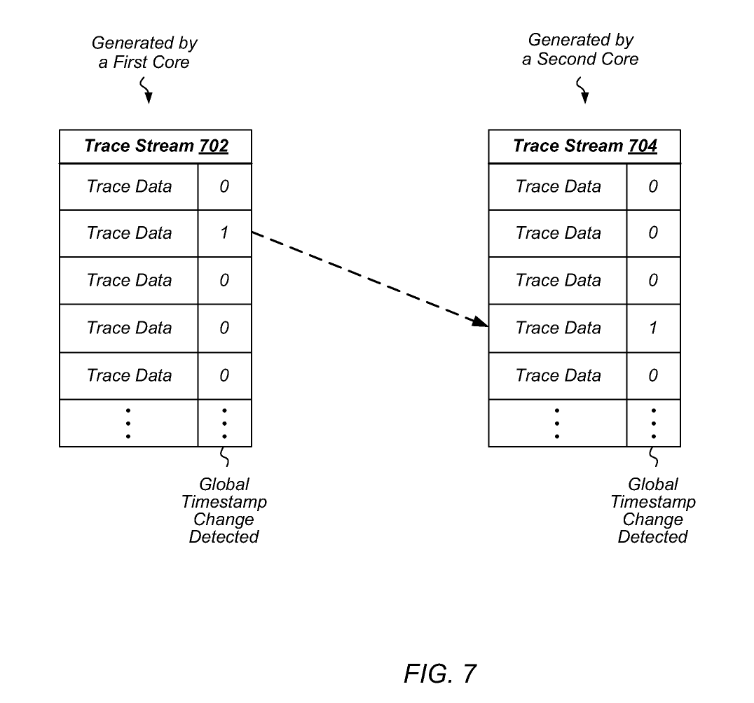

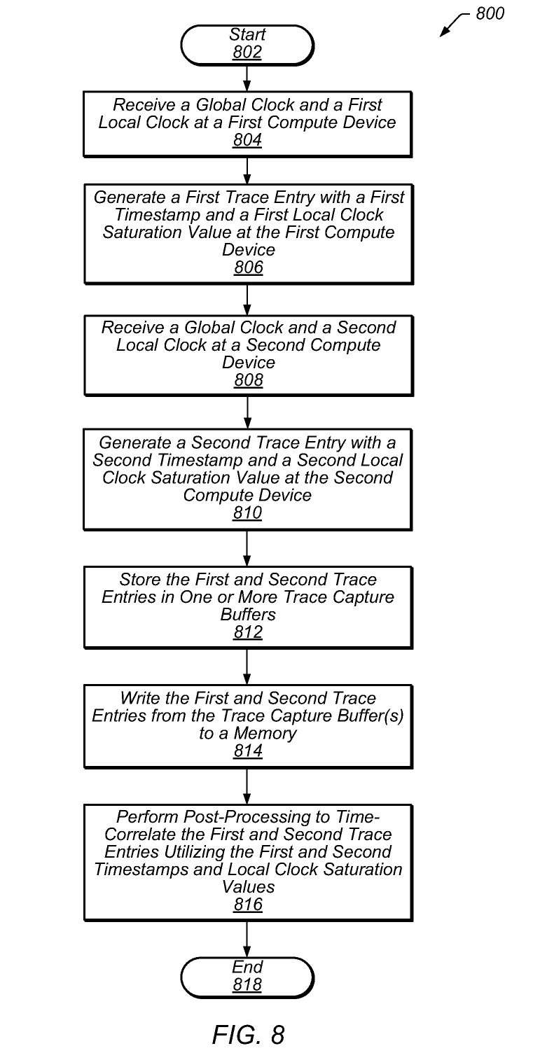

Referring now to FIG. 6, a generalized flow diagram of one embodiment of a method 600 for switching between a temperature measurement mode and a calibration mode is shown. The components embodied in the temperature monitor 100 and the acquisition and processing system 200 described above may generally operate in accordance with method 600. For purposes of discussion, the steps in this embodiment and subsequent embodiments of methods described later are shown in sequential order. However, some steps may occur in a different order than shown, some steps may be performed concurrently, some steps may be combined with other steps, and some steps may be absent in another embodiment.

In block 602, an ideal, or expected, gain for each component within a data processing circuitry is determined. In block 604, one or more stable reference voltages are provided, such as with a bandgap circuit. In block 606, an expected output value for the data processing circuitry is computed with the ideal gains and the reference voltages as inputs. This value may be a theoretical value.

If a temperature measurement mode is detected, rather than a calibration mode, for operation (conditional block 608), then in block 610, one or more sense voltages sampled during a temperature sampling period are selected as input voltages to the data processing circuitry. In block 612, an output value is generated from the data processing circuitry with the sense voltages as inputs. In block 614, the output value is adjusted with a scaling factor. The scaling factor may be stored and updated over time.

If a calibration mode is detected, rather than a temperature measurement mode, for operation (conditional block 608), then in block 616, the one or more stable calibration reference voltages are selected as input voltages to the data processing circuitry. In block 618, an output value is generated from the data processing circuitry with the stable calibration reference voltages as inputs. In block 620, a scaling factor is computed using the generated output value and the expected output value. The new scaling factor may replace a previously stored scaling factor and may be used in subsequent temperature measurements.

It is noted that the above-described embodiments may comprise software. In such an embodiment, the program instructions that implement the methods and/or mechanisms may be conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Additionally, program instructions may comprise behavioral-level description or register-transfer level (RTL) descriptions of the hardware functionality in a high level programming language such as C, or a design language (HDL) such as Verilog, VHDL, or database format such as GDS II stream format (GDSII). In some cases the description may be read by a synthesis tool, which may synthesize the description to produce a netlist comprising a list of gates from a synthesis library. The netlist comprises a set of gates, which also represent the functionality of the hardware comprising the system. The netlist may then be placed and routed to produce a data set describing geometric shapes to be applied to masks. The masks may then be used in various semiconductor fabrication steps to produce a semiconductor circuit or circuits corresponding to the system. Alternatively, the instructions on the computer accessible storage medium may be the netlist (with or without the synthesis library) or the data set, as desired. Additionally, the instructions may be utilized for purposes of emulation by a hardware based type emulator from such vendors as Cadence®, EVE®, and Mentor Graphics®.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A temperature measurement circuit comprising:
data processing circuitry configured to:
select one or more reference voltages as input voltages, in response to detecting a calibration mode of operation; and
generate a temperature value based on the input voltages; and
calibration circuitry configured to:
generate the one or more reference voltages; and
determine a scaling factor by calculating a ratio of an expected temperature value to the generated temperature value, in response to detecting a calibration mode of operation.

2. The temperature measurement circuit as recited in claim 1, further comprising a thermal sensor circuit configured to generate one or more sense voltages, wherein the data processing circuitry is further configured to select the one or more sense voltages as input voltages, in response to detecting a measurement mode of operation.

3. The temperature measurement circuit as recited in claim 2, wherein in response to detecting a measurement mode of operation, the data processing circuitry is further configured to adjust the temperature value according to the scaling factor.

4. The temperature measurement circuit as recited in claim 3, wherein the data processing circuitry comprises a plurality of data processing components, each with an associated gain.

5. The temperature measurement circuit as recited in claim 4, wherein the expected temperature value is a value based on the reference voltages and generated by the data processing circuitry.

6. The temperature measurement circuit as recited in claim 3, wherein adjusting the temperature value comprises multiplying the temperature value and the scaled factor.

7. The temperature measurement circuit as recited in claim 3, wherein the one or more generated sense voltages are associated with a given area of an integrated circuit.

8. The temperature measurement circuit as recited in claim 3, wherein the calibration circuitry is further configured to utilize a bandgap circuit to generate the one or more reference voltages.

9. A method comprising:
generating one or more reference voltages;
selecting the one or more reference voltages as input voltages to data processing circuitry, in response to detecting a calibration mode of operation;
generating a temperature value based on the input voltages;
in response to detecting a calibration mode of operation, determining a scaling factor by calculating a ratio of an expected temperature value to the generated temperature value.

10. The method as recited in claim 9, further comprising:
generating one or more sense voltages with a thermal sensor circuit; and
selecting the one or more sense voltages as input voltages to data processing circuitry, in response to detecting a measurement mode of operation.

11. The method as recited in claim 10, wherein in response to detecting a measurement mode of operation, the method further comprises adjusting the temperature value according to the scaled factor.

12. The method as recited in claim 11, wherein the data processing circuitry comprises a plurality of data processing components, each with an associated gain.

13. The method as recited in claim 12, wherein the expected temperature value is a value based on the reference voltages and generated by the data processing circuitry.

14. The method as recited in claim 11, further comprising adjusting the temperature value by multiplying the temperature value and the scaled factor.

15. The method as recited in claim 11, further comprising utilizing a bandgap circuit to generate the one or more reference voltages.

16. The method as recited in claim 11, further comprising generating the temperature value as a digital code.

17. A computer system comprising:
an integrated circuit (IC) comprising an on-die temperature measurement circuit configured to:
generate one or more reference voltages;
select the one or more reference voltages as input voltages to data processing circuitry, in response to detecting a calibration mode of operation;
generate a temperature value based on the input voltages;
in response to detecting a calibration mode of operation, determine a scaling factor by calculating a ratio of an expected temperature value to the generated temperature value; and
a thermal cooling controller configured to:
receive the generated temperature value; and
change a condition of operation for the IC in response to determining the temperature value exceeds a given threshold.

18. The computer system as recited in claim 17, wherein the temperature measurement circuit is further configured to:
generate one or more sense voltages with a thermal sensor circuit; and
select the one or more sense voltages as input voltages to data processing circuitry, in response to detecting a measurement mode of operation.

19. The computer system as recited in claim 18, wherein in response to detecting a measurement mode of operation, the temperature measurement circuit is further configured to adjust the temperature value according to the scaled factor.

20. The computer system as recited in claim 19, wherein changing the condition of operation by the thermal cooling controller comprises at least one of the following:
selecting a lower performance-power state and increasing a speed of a fan.

21. An integrated circuit comprising:
a thermal detector circuit configured to operate in at least a calibration mode and an operational mode;
wherein when operating in a calibration mode, the thermal detector circuit is configured to determine an adjustment value based on a difference between a first value generated by the thermal detector using a reference voltage and an expected value associated with the reference voltage;
wherein when operating in the operational mode, the thermal detector circuit is configured to adjust a second value generated based on a voltage generated at a thermal sensor using the adjustment value to generate a third value, the third value representing a temperature at a location of the integrated circuit.

22. The integrated circuit as recited in claim 21, wherein the adjustment value represents a value used to correct for gain mismatches in the integrated circuit.

23. The integrated circuit as recited in claim 22, wherein the adjustment value may be used as at least one of a multiplicative, divisive, additive, subtractive, or offset value.
